(19) United States
(12) Patent Application Publication
(10) Pub. No.: US 2005/0179521 A1
(43) Pub. Date: Aug. 18, 2005

(54) Frequency hopping method for RFID tag

(75) Inventors: Vijay Pillai, Mukilteo, WA (US); Rene D. Martinez, Seattle, WA (US); Shashi Ramamurthy, White Plains, NY (US)

Correspondence Address: Rodney T. Hodgson, Ph.D., 822 Pines Bridge Rd., Ossining, NY, 10562, US

(73) Assignee: Intermec IP Corp., Woodland Hills, CA (US)

(21) Appl. No.: 10/779,320

(22) Filed: Feb. 12, 2004

(51) Int. Cl. H04Q 5/22

(52) U.S. Cl. 340/10.34; 375/132

(57) ABSTRACT

Radio frequency (RF) power is sent out by a base station to radio frequency identification transponders (RFID tags) for a first time at a first frequency. The frequency is changed to a second frequency, and the RF power sent out for a second time substantially different from the first time.

### FIELD OF THE INVENTION

The field of the invention is the field of radio frequency (RF) identification (RFID) transponders (tags), and systems for their use.

### BACKGROUND OF THE INVENTION

RF Transponders (RF Tags) can be used in a multiplicity of ways for locating and identifying accompanying objects and transmitting information about the state of the object. It has been known since the early 60's in U.S. Pat. No. 3,098,971 by R. M. Richardson, that electronic components of transponders could be powered by radio frequency (RF) electromagnetic (EM) waves sent by a “base station” and received by a tag antenna on the transponder. The RF EM field induces an alternating current in the transponder antenna which can be rectified by an RF diode on the transponder, and the rectified current can be used for a power supply for the electronic components of the transponder. The transponder antenna loading is changed by something that was to be measured, for example a microphone resistance in the cited patent. The oscillating current induced in the transponder antenna from the incoming RF energy would thus be changed, and the change in the oscillating current led to a change in the RF power radiated from the transponder antenna. This change in the radiated power from the transponder antenna could be picked up by the base station antenna and thus the microphone would in effect broadcast power without itself having a self contained power supply. The “rebroadcast” of the incoming RF energy is conventionally called “back scattering”, even though the transponder broadcasts the energy in a pattern determined solely by the transponder antenna. Since this type of transponder carries no source of energy of its own, it is called a “passive” transponder to distinguish it from a transponder containing a battery or other energy supply, conventionally called an active transponder. The power supply of the passive transponder is typically a capacitor which is charged by rectifying the RF power signal sent out by the base station, but may be any source of power which is energized by an external signal.

Active transponders with batteries or other independent energy storage and supply means such as fuel cells, solar cells, radioactive energy sources etc. can carry enough energy to energize logic, memory, and tag antenna control circuits. However, the usual problems with life and expense limit the usefulness of such transponders.

In the 70's, suggestions to use backscatter transponders with memories were made. In this way, the transponder could not only be used to measure some characteristic, for example the temperature of an animal in U.S. Pat. No. 4,075,632 to Baldwin et. al., but could also identify the animal.

The continuing march of semiconductor technology to smaller, faster, and less power hungry has allowed enormous increases of function and enormous drop of cost of such transponders. Presently available research and development technology will also allow new function and different products in communications technology. However, the new functions allowed and desired consume more and more power, even though the individual components consume less power.

It is thus of increasing importance to be able to power the transponders adequately and increase the range which at which they can be used. One method of powering the transponders suggested is to send information back and forth to the transponder using normal RF techniques and to transport power by some means other than the RF power at the communications frequency. However, such means require use of possibly two tag antennas or more complicated electronics.

Sending a swept frequency to a transponder was suggested in U.S. Pat. No. 3,774,205. The transponder would have elements resonant at different frequencies connected to the tag antenna, so that when the frequency swept over one of the resonances, the tag antenna response would change, and the backscattered signal could be picked up and the resonance pattern detected.

Prior art systems can interrogate the tags if more than one tag is in the field. U.S. Pat. No. 5,214,410, hereby incorporated by reference, teaches a method for a base station to communicate with a plurality of tags.

Sending at least two frequencies from at least two antennas to avoid the “dead spots” caused by reflection of the RF was proposed in EPO 598 624 A1, by Marsh et al. The two frequencies would be transmitted simultaneously, so that a transponder in the “dead spot” of one frequency would never be without power and lose its memory of the preceding transaction.

The prior art teaches a method to interrogate a plurality of tags in the field of the base station. The tags are energized, and send a response signal at random times. If the base station can read a tag unimpeded by signals from other tags, the base station interrupts the interrogation signal, and the tag which is sending and has been identified, shuts down. The process continues until all tags in the field have been identified. If the number of possible tags in the field is large, this process can take a very long time. The average time between the random responses of the tags must be set very long so that there is a reasonable probability that a tag can communicate in a time window free of interference from the other tags.

In order that the prior art methods of communicating with a multiplicity of tags can be carried out, it is important that the tags continue to receive power for the tag electronics during the entire communication period. If the power reception is interrupted for a length of time which exceeds the energy storage time of the tag power supply, the tag “loses” the memory that it was turned off from communication, and will restart trying to communicate with the base station, and interfere with the orderly communication between the base station and the multiplicity of tags.

The amount of power that can be broadcast in each RF band is severely limited by law and regulation to avoid interference between two users of the electromagnetic spectrum. For some particular RF bands, there are two limits on the power radiated. One limit is a limit on the continuously radiated power in a particular bandwidth, and another limit is a limit on peak power. The amount of power that can be pulsed in a particular frequency band for a short time is much higher than that which can be broadcast continuously.

Federal Communications Commission Regulation 15.247 and 15.249 of Apr. 25, 1989 (47 C.F.R. 15.247 and 15.249) regulates the communications transmissions on bands 902-928 MHZ, 2400-2483.5 MHZ, and 5725-5850 MHZ. In this section, intentional communications transmitters are allowed to communicate to a receiver by frequently changing frequencies on both the transmitter and the receiver in synchronism or by “spreading out” the power over a broader bandwidth. The receiver is, however, required to change the reception frequency in synchronism with the transmitter.

### RELATED PATENTS AND APPLICATIONS

The following U.S. Patents and Patent Applications are assigned to the assignee of the present invention: U.S. Pat. Nos.: 6,320,896, 6,327,312, 6,005,530, 6,122,329, 6,501,807, 6,294,997, 6,166,638, 6,441,740, 6,104,291, 5,939,984, 6,140,146, 6,259,408, 6,236,223, 6,249,227, 6,201,474, 6,100,804, 6,294,996, 6,486,769, 6,121,880, 6,518,885, 6,593,845, 6,320,509, 6,639,509, 5,485,520, 6,275,157, 6,285,342, 6,366,260, 6,215,402, 6,118,379, 6,177,872, 6,281,794, 6,130,612, 6,147,606, 6,288,629, 6,172,596, 6,566,850, 6,535,175; 5,850,181; 5,828,693;; and U.S. patent application Ser. Nos. 09/394,241 filed Sep. 13, 1999, 10/056,398 filed Jan. 23, 2002, and 60/459,414 filed Mar. 31, 2003. The above patents and patent applications are hereby incorporated by reference.

### OBJECTS OF THE INVENTION

It is an object of the invention to produce a method, an apparatus, and a system communicating between a base station and at least one tag which decreases the time taken to identify the tag or tags.

### SUMMARY OF THE INVENTION

Information is communicated between a base station and at least one tag by sending RF power Pⱼ for a first time tⱼ to the tag at a first frequency ƒⱼ from the base station to the tag, then sending power for a second time tₖ to the tag at a second frequency ƒₖ, where tⱼ and tₖ are substantially different times.

### BRIEF DESCRIPTION OF THE DRAWINGS

FIG. 1A is the power and FIG. 1B is the frequency transmitted as a function of time in the prior art.

FIG. 2A is the power and FIG. 2B is the frequency transmitted as a function of time in one of the preferred methods of the invention.

FIG. 3 is block diagram of a preferred method of the invention.

### DETAILED DESCRIPTION OF THE INVENTION

U.S. Pat. No. 5,828,693 to Mays, et al. issued Oct. 27, 1998 entitled Spread spectrum frequency hopping reader system and U.S. Pat. No. 5,850,181 to Heinrich, et al. issued Dec. 15, 1998 entitled Method of transporting radio frequency power to energize radio frequency identification transponders, assigned to the assignee of the present invention, give details on RFID tags powered by an RF field where the frequency sent to the tags hops from frequency to frequency chosen from a pseudorandomly ordered list of frequencies. In both the above described patents, the RF field is sent out to the tags from a base station as a series of bursts of power at a particular frequency, with the frequency changing for the next burst, but the power and the length of time of the bursts are kept constant. U.S. Pat. No. 5,828,693 teaches that the length of time of each burst the regular series of bursts may be changed to avoid having one or more base stations interfering with one another. Apparatus and methods for changing the frequency and the power sent out by the tags are well described in these patents. The above patents are hereby incorporated by reference.

In a preferred communication between a base station and a group of tags, each tag is identified, and then instructed to take no further part in the communication unless it is called upon to do so by calling its identification number. Since two tags “talking” at the same time to the base station will interfere with each other, a tag which has once been identified, and which loses its “memory” that it was identified, will slow the communication with the group down because it will have to be re-identified and re-instructed to keep silence. In the U.S. Pat. No. 5,850,181 referred to above, the importance of keeping the tag functional by not allowing the power in the tag to drop below a minimum was pointed out. In a preferred embodiment, well described in copending application Ser. No. 10/056,398 assigned to the assignee of the present invention filed Jan. 23, 2002 by Heinrich et al., power is provided for a long time t₀ to just one device or function on the tag . . . the device or “flag” which tells the tag that it has been identified. A separate power supply such as a capacitor is provided which provides power only to the flag for a time t₀ long compared to the normal tag power down time when all the tag electronics are drawing current (which could be as short at 50 microsec). Such a situation may occur, for example, when the frequency sent to the tag changes, and the tag is in a position where multipath effects drop the power received by the already identified tag below that power which the tag needs to be fully functional. If the tag flag remains set until the frequency is changed again and the multipath transmission changes so the tag is powered once again, the tag remembers that it has been identified, and does not interrupt communications by trying to contact the base station. The above application Ser. No. 10/056,398 is hereby incorporated by reference.

When a group of tags is being interrogated by a base station, the base station according to the prior art sends out signals at a frequency ƒᵢ for a fixed time tᵢ, and then changes frequency to another frequency ƒⱼ chosen from a list of frequencies listed in pseudorandom order, and then sends frequency ƒⱼ for the same time tᵢ. This process is continued until all tags have been identified. It may be, however, that the base station sends out a command for unidentified tags in the field to respond, and no tags respond, either because all tags in the field have been identified or because some tags in the field do not receive power because of the above identified multipath problems. Presently, the base station continues to send power at the same frequency and power for the same amount of time regardless of whether a tag in the field responds. The base station continues through the pseudorandomly ordered list of frequencies, and either stops transmission or starts again at the beginning of the list. U.S. Pat. No. 5,828,693 mentions that the amount of time that a base station sends out a particular frequency before the frequency changes may be changed, but does not state conditions for such changes. In particular, U.S. Pat. No. 5,828,693 does not specify that the length of time taken to change the time interval shall be less than the time taken to power down the tag or the time for the flag to reset.

In the most preferred method of the present invention, the base station changes frequency as soon as no tags respond, so that those unidentified tags which are silent because they are in a multipath power minimum at frequency ƒⱼ will see a different frequency ƒⱼ₊₁, for which the multipath minima are in a different spatial positions. For example, at 2.4 GHz, the frequency might be changed in the prior art every 300 or 400 msec. However, the base station can tell if one or more tags is responding in as little as 10 ms. Thus, the base station will change frequencies in as little as 10 or 20 ms as soon as no more tags respond. Preferably, when the time is changed from a time tⱼ to another time tⱼ₊₁, tⱼ₊₁ will be less than tⱼ/2. More preferably, tⱼ₊₁ will be less than tⱼ/4, and most preferably tⱼ₊₁ will be less than tⱼ/10. To take into account that tⱼ₊₁ may also be longer than tⱼ, preferably |tⱼ₊₁−tⱼ|>0.05 (tⱼ+tⱼ₊₁), more preferably |tⱼ₊₁−tⱼ|>0.1 (tⱼ+tⱼ₊₁) and most preferably |tⱼ₊₁−tⱼ|>0.3 (tⱼ+tⱼ₊₁).

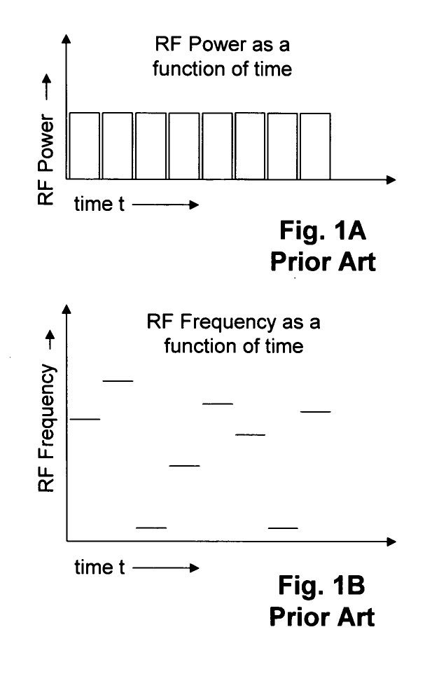

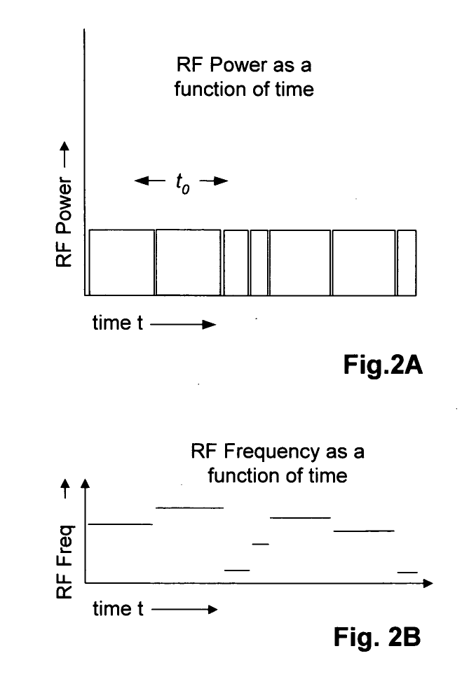

FIGS. 1A and 1B show the prior art sent out RF power and frequency as a function of time. The frequency is changed at regular times, and the power is greatly reduced as the frequency is changed. FIG. 2A shows a sketch of RF power as a function of time for the method of the invention. After sending out a power Pᵢ at a frequency ƒᵢ for a time tᵢ, the frequency is changed and a new frequency chosen in order from a list of frequencies listed in pseudorandom order. Instead of sending a new frequency ƒⱼ for the same time tᵢ, the frequency ƒⱼ is sent out for a time tⱼ which is substantially different from tᵢ. The time taken to change the frequency from ƒᵢ to ƒⱼ and the timing from tᵢ to tⱼ must be less than the time t₀ for the tag flag to be reset, and is preferably less than the time taken for the tag to power down once the RF field drops to zero. While the power levels sent out in FIG. 2A are shown to be constant with time, the invention anticipates that the power level sent out may change as a function of time. The power level may be an increasing or decreasing stairstep function, or indeed any regular function of time.

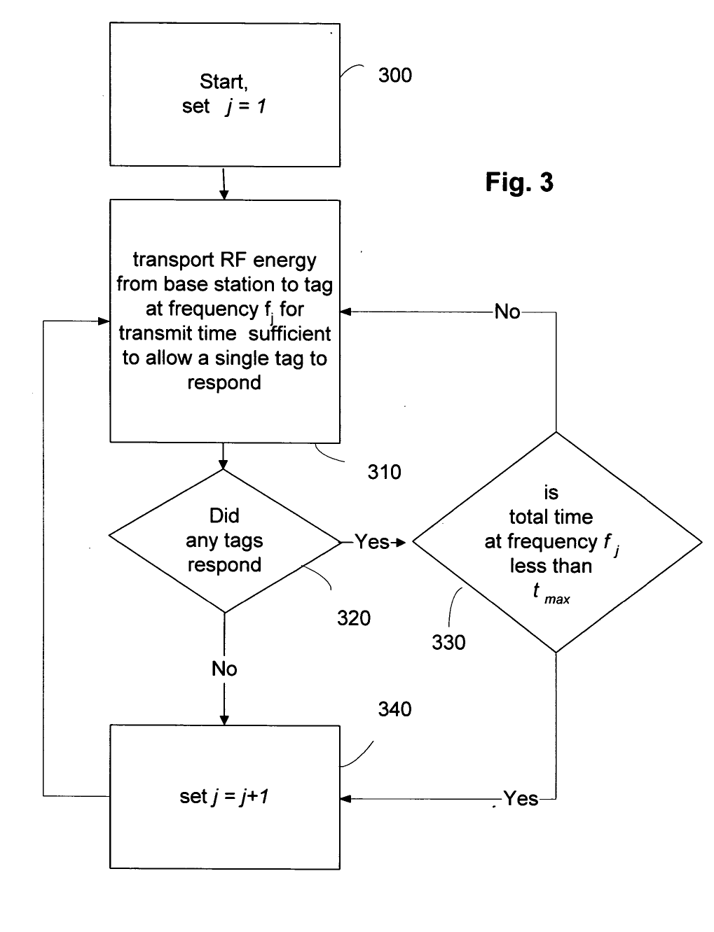

FIG. 3 shows a block diagram of the most preferred method of the invention. The base station starts by choosing the first frequency in the ordered list and sets j=1 in step 300. Then, the base station sends out RF energy a frequency ƒⱼ for a time sufficient for a single tag to respond in step 310. In decision step 320, the base station decides whether one or more tags responded. If one or more tags responded, another decision step 320 decides whether the total time tⱼ spent sending out frequency ƒⱼ exceeds a maximum time limit tₘₐₓ for sending out a single frequency at the power sent. Government regulations prohibit power of over a certain limit being sent out for more than a defined time. The protocol sets a maximum time limit tₘₐₓ (which may optionally depend on power sent out) for sending out one frequency, and when that time limit has been exceeded, the index j is changed to j+1 in step 340, and the system returns to step 310 to send out another the next frequency ƒⱼ₊₁ in the lists. If no tags responded in step 320, the system goes immediately to step 340 and to change frequency to the next frequency ƒⱼ₊₁ in the list.

In the most preferred method of the invention, the maximum time tₘₐₓ for sending out a single frequency may be reached while the first frequency is being sent out, since there are many unread tags in the field. Eventually, however, most tags have been read, and at that time, no tags return signals before the maximum time tₘₐₓ has been reached. Then, the base station cycles through the remaining frequencies in the list, or the base station decides that all tags have been identified, and starts the remainder of the protocol for communicating with the tags. It is anticipated by the inventors that the time for sending out the frequency fⱼ₊₁ in the list of frequencies could in fact be longer than the time for sending out the prior frequency fⱼ, as new tags could move into the field during the communication procedure.

It is anticipated by the inventors that the base station could send out various power levels during the communication, since fewer tags would be in effective communication with the base station if the sent out power was lower, and hence the fewer tags could be identified rapidly. Then, the power could be raised to “catch” more of the tags in the field. Alternatively, the power could be sent out high at first, and if more than one tag responds the power could be reduced to reduce the number of tags in effective communication with the base station.

Obviously, many modifications and variations of the present invention are possible in light of the above teachings. It is therefore to be understood that, within the scope of the appended claims, the invention may be practiced otherwise than as specifically described.

1. A method, comprising:
sending power to at least one radio frequency (RF) identification (RFID) transponder (tag) by;
a) sending power Pⱼ for a first time tⱼ to the tag at a first frequency ƒⱼ chosen from a list of N frequencies ƒ₁ . . . ƒⱼ, ƒⱼ₊₁ . . . ƒ_{N}; and then
b) sending power Pⱼ₊₁ for a time tⱼ₊₁ to the tag at a second frequency ƒⱼ₊₁ chosen from the list of N frequencies, wherein tⱼ and tⱼ₊₁ are substantially different times, and wherein the time between sending power Pⱼ and Pⱼ₊₁ is less than a time t₀ in which the tag loses a particular tag function if no power is sent to the tag.

2. The method of claim 1, wherein tⱼ₊₁ is chosen to be long enough that all tags in operative communication with the base station at frequency ƒⱼ₊₁ have identifed themselves.

3. The method of claim 1, wherein the sending of power Pⱼ₊₁ is stopped after a time tⱼ₊₁ when no further tags identify themselves.

4. The method of claim 1, wherein Pⱼ and Pⱼ₊₁ are substantially different powers.

5. The method of claim 4, wherein Pⱼ₊₁ is substantially reduced from Pⱼ when tⱼ is too short a time for all tags in operative communication with the base station to identified themselves.

6. The method of claim 1, wherein |tⱼ₊₁−tⱼ|>0.05 (tⱼ+tⱼ₊₁).

7. The method of claim 6, wherein |tⱼ₊₁−tⱼ|>0.1 (tⱼ+tⱼ₊₁).

8. The method of claim 7, wherein |tⱼ₊₁−tⱼ|>0.3 (tⱼ+tⱼ₊₁).

9. The method of claim 1, wherein Pⱼ is a function of time.

10. The method of claim 9, wherein Pⱼ is a monotonically increasing function of time.

11. The method of claim 10, wherein Pⱼ is increased when no further tags identify themselves.
